(19) United States
(12) Patent Application Publication
(10) Pub. No.: US 2008/0023578 A1
(43) Pub. Date: Jan. 31, 2008

(54) Valve Assembly for an Injection Valve and Injection Valve

(76) Inventor: Mauro Grandi, Livorno (IT)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/779,702

(22) Filed: Jul. 18, 2007

(30) Foreign Application Priority Data
Jul. 25, 2006 (EP) 06015488

(51) Int. Cl. F02M 61/00

(52) U.S. Cl. 239/533.2

(57) ABSTRACT

A valve assembly for an injection valve has a valve body including a central longitudinal axis and a cavity with a fluid inlet portion and a fluid outlet portion, a valve needle axially movable in the cavity, the valve needle preventing a fluid flow through the fluid outlet portion in a closing position and releasing the fluid flow through the fluid outlet portion in further positions, and a fluid flow directing element arranged in the cavity and having a recess to direct the fluid flow to the fluid outlet portion, the recess having a recess fluid inlet portion and a channel portion arranged between the recess fluid inlet portion and the fluid outlet portion, the channel portion having an upstream end and a downstream end. The cross section of the downstream end of the channel portion being smaller than the cross section of the upstream end of the channel portion.

### CROSS-REFERENCE TO RELATED APPLICATIONS

This application claims priority from European Patent Application No. 06015488 which was filed on Jul. 25, 2006, and is incorporated herein by reference in its entirety.

### TECHNICAL FIELD

The invention relates to a valve assembly for an injection valve and an injection valve.

### BACKGROUND

Injection valves are in wide spread use, in particular for internal combustion engines where they may be arranged in order to dose the fluid into an intake manifold of the internal combustion engine or directly into the combustion chamber of a cylinder of the internal combustion engine.

Injection valves are manufactured in various forms in order to satisfy the various needs for the various combustion engines. Therefore, for example, their length, their diameter and also various elements of the injection valve being responsible for the way the fluid is dosed may vary in a wide range. In addition to that, injection valves may accommodate an actuator for actuating a needle of the injection valve, which may, for example, be an electromagnetic actuator or piezo electric actuator.

In order to enhance the combustion process in view of the creation of unwanted emissions, the respective injection valve may be suited to dose fluids under very high pressures. The pressures may be in case of a gasoline engine, for example, in the range of up to 200 bar and in the case of diesel engines in the range of up to 2000 bar.

### SUMMARY

A valve assembly comprising a reliable and precise function can be achieved by an embodiment in which a valve assembly for an injection valve, may comprise a valve body having a central longitudinal axis and comprising a cavity with a fluid inlet portion and a fluid outlet portion, a valve needle axially movable in the cavity for closing an opening of the valve assembly, and a fluid flow directing element arranged in the cavity and comprising a recess to direct the fluid flow to the fluid outlet portion, the recess having a recess fluid inlet portion and a channel portion arranged between the recess fluid inlet portion and the fluid outlet portion, and a cross section of the recess fluid inlet portion being greater than a cross section of the channel portion.

According to another embodiment, a valve assembly for an injection valve, may comprise a valve body including a central longitudinal axis, the valve body comprising a cavity with a fluid inlet portion and a fluid outlet portion, a valve needle axially movable in the cavity, the valve needle preventing a fluid flow through the fluid outlet portion in a closing position and releasing the fluid flow through the fluid outlet portion in further positions, and a fluid flow directing element arranged in the cavity and comprising a recess to direct the fluid flow to the fluid outlet portion, the recess having a recess fluid inlet portion and a channel portion arranged between the recess fluid inlet portion and the fluid outlet portion, the channel portion having an upstream end and a downstream end, and a cross section of the downstream end of the channel portion being smaller than a cross section of the upstream end of the channel portion.

### BRIEF DESCRIPTION OF THE DRAWINGS

Exemplary embodiments of the invention are explained in the following with the aid of schematic drawings. These are as follows:

FIG. 1, an injection valve with a valve assembly in a longitudinal section view,

FIG. 2, section II of the valve assembly of the injection valve according to FIG. 1 in a longitudinal section view,

FIG. 3, a fluid flow directing element of the valve assembly of the injection valve in a cross section view,

FIG. 4, an enlarged view of a section of the fluid flow directing element of the valve assembly of the injection valve in a cross section view in one embodiment,

FIG. 5, an enlarged view of a section of the fluid flow directing element of the valve assembly of the injection valve in a cross section view in a second embodiment, and

FIG. 6, an enlarged view of a section of the fluid flow directing element of the valve assembly of the injection valve in a cross section view in a further embodiment.

Elements of the same design and function that appear in different illustrations are identified by the same reference character.

### DETAILED DESCRIPTION

According to various embodiments, a valve assembly for an injection valve, may comprise a valve body including a central longitudinal axis, the valve body comprising a cavity with a fluid inlet portion and a fluid outlet portion, and a valve needle axially moveable in the cavity, the valve needle preventing a fluid flow through the fluid outlet portion in a closing position and releasing the fluid flow through the fluid outlet portion in further positions. Furthermore, the valve assembly comprises a fluid flow directing element arranged in the cavity and comprises a recess to direct the fluid flow to the fluid outlet portion. The recess has a recess fluid inlet portion and a channel portion arranged between the recess fluid inlet portion and the fluid outlet portion, and the channel portion has an upstream end and a downstream end. The cross section of the downstream end of the channel portion is smaller than the cross section of the upstream end of the channel portion.

The characteristic of the fluid flow releasing through the fluid outlet portion can be strongly influenced by the shape of the valve assembly in the area of the fluid outlet portion. The advantage according to various embodiments is that the fluid flow receives a high fluid flow velocity available at the downstream end of the channel portion where the fluid leaves the fluid flow directing element. By this, a high fuel pressure is available at the downstream end of the channel portion and, consequently, a large cone angle of the spray of the fluid is possible.

Preferably, the cross-section of the channel portion can be decreasing continuously from the upstream end of the channel portion to the downstream end of the channel portion. This has the advantage that the highest velocities of the fluid are available at the downstream end of the channel portion. This can increase the tangential speed of the fluid flow when the fluid flow leaves the fluid flow directing element.

According to an embodiment, the recess fluid inlet portion and the channel portion are formed and arranged in a way that the transition between the recess fluid inlet portion and the channel portion is stepless. By this, small pressure losses at the upstream end of the channel portion are possible. Consequently, a big fluid pressure is available at the downstream end of the channel portion and the radial component of the fluid flow releasing through the fluid outlet portion can be large. This makes is possible that the fluid flow releasing through the fluid outlet portion, which can be a spray, can have a big spray angle and a favorable distribution of fluid droplets.

Preferably, the channel portion may have a conical shape. Conical shapes can be easily manufactured. A stepless transition between the channel portion and the recess fluid inlet portion of the fluid flow directing element is possible. Furthermore, the conical shape enables small pressure losses at the upstream end of the channel portion.

According to a further embodiment, a longitudinal section of the channel portion is of a convex shape. This has the advantage that a stepless transition between the channel portion and the recess fluid inlet portion is possible. Furthermore, a high fluid velocity is available at the downstream end of the channel portion.

According to a further embodiment, the longitudinal section of the channel portion is of a concave shape. This allows a stepless transition between the channel portion and the recess fluid inlet portion.

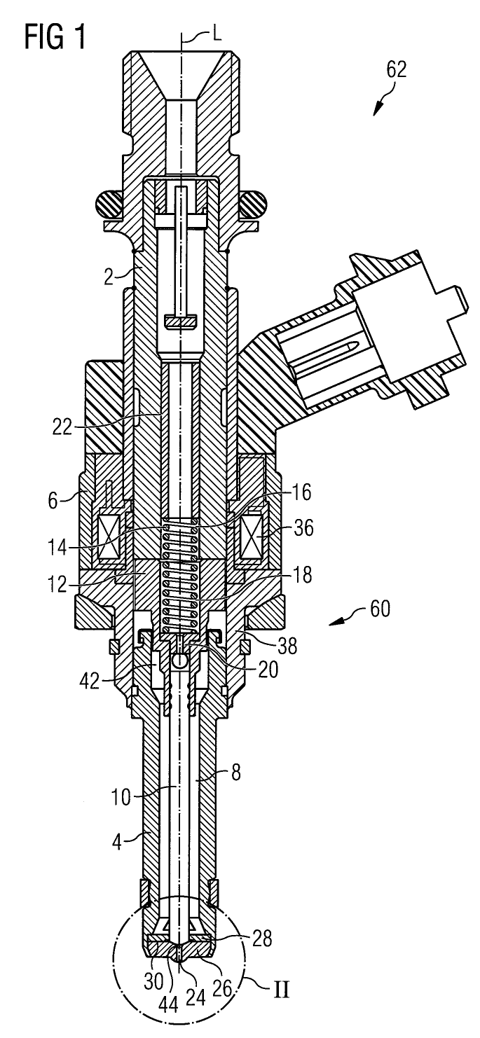

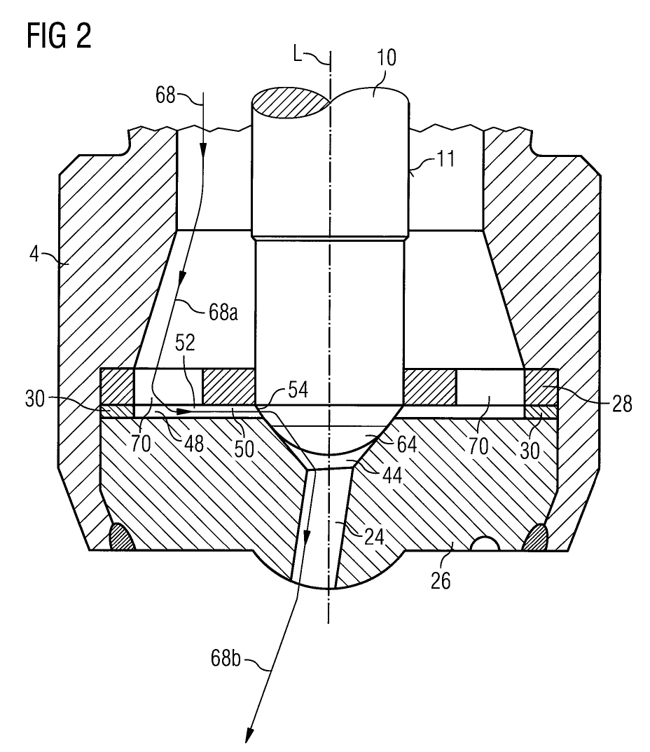

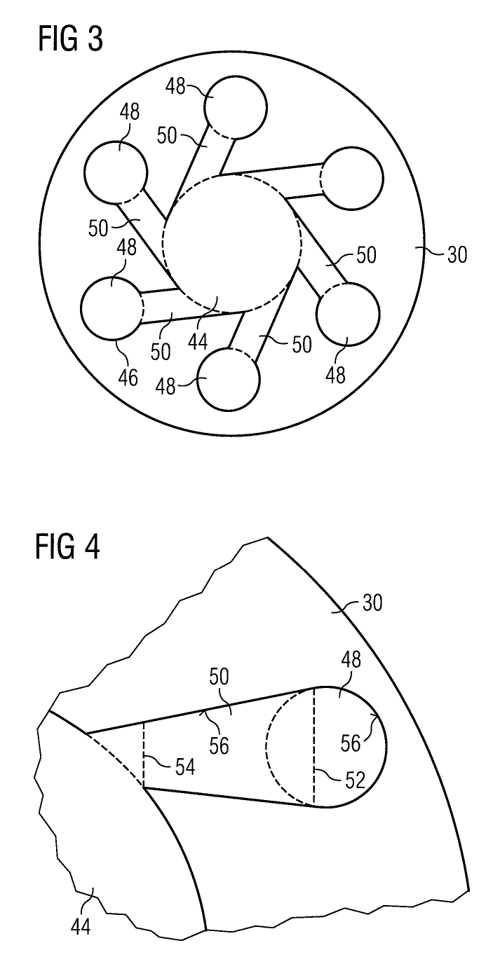

An injection valve 62 (FIG. 1), that is in particular suitable for dosing fuel to an internal combustion engine, comprises an inlet tube 2, a housing 6 and a valve assembly 60.

The valve assembly 60 comprises a valve body 4 with a central longitudinal axis L and a cavity 8, which may take in a valve needle 10 and preferably a part of an armature 12. The valve needle 10 has a surface 11 and a seat part 64. In the inlet tube 2 a recess 16 is provided which further extends to a recess 18 of the armature 12. A spring 14 is arranged in the recess 16 of the inlet tube 2 and/or the recess 18 of the armature 12. Preferably, it may rest on a spring seat being formed by an anti-bounce disc 20. By this the spring 14 is mechanically coupled to the needle 10. An adjusting tube 22 is provided in the recess 16 of the inlet tube 2. The adjusting tube 22 forms a further seat for the spring 14 and may be axially moved during the manufacturing process of the fluid injection valve in order to preload the spring 14 in a desired way.

In a closing position of the needle 10 it sealingly rests on a seat plate 26 by this preventing a fluid flow through at least one injection nozzle 24. The injection nozzle 24 may be, for example, an injection hole. However, it may also be of some other type suitable for dosing fluid. The seat plate 26 may be made in one part with the valve body 4 or a separate part from the valve body 4. In addition to that a lower guide 28 for guiding the needle 10 is provided. The lower guide 28 further comprises an orifice 70 for guiding the fluid flow.

Additionally, a fluid flow directing element 30 is provided which is arranged in the cavity 8 between the lower guide 28 and the seat plate 26.

The injection valve is provided with an actuator unit, that may comprise preferably an electromagnetic actuator, comprising a coil 36, which may preferably be overmolded. A valve body shell 38, the armature 12 and the inlet tube 2 are forming an electromagnetic circuit. The actuator unit may, however, also comprise another type of actuator, which is known to a person skilled in the art for that purpose. Such an actuator may be, for example, a piezoelectric actuator.

A fluid inlet portion 42 is provided in the valve body 4 which communicates with a fluid outlet portion 44 which is a part of the cavity 8 near the seat plate 26.

The fluid flow directing element 30 has the shape of a cylindrical disk. The fluid flow directing element 30 comprises recesses 46 to direct the fluid flow to the fluid outlet portion 44. Each of the recesses 46 has a recess fluid inlet portion 48 and a channel portion 50, both with an inner surface 56. The recess fluid inlet portion 48 is hydraulically coupled to the orifice 70 in the lower guide 28. The channel portion 50 has an upstream end 52 and a downstream end 54. At the upstream end 52 the channel portion 50 is hydraulically coupled with the recess fluid inlet portion 48. The downstream end 54 of the channel portion 50 enables a hydraulic coupling of the channel portion 50 with the fluid outlet portion 44.

The cross-section of the upstream end 52 of the channel portion 50 is larger than the cross-section of the downstream end 54 of the channel portion 50. Therefore, the velocity of the fluid flow at the downstream end 54 of the channel portion 50 is higher than the velocity of the fluid flow at the upstream end 52 of the channel portion 50.

The cross-section of the channel portion 50 is decreasing continuously from the upstream end 52 of the channel portion 50 to the downstream end 54 of the channel portion 50. Therefore, the highest velocities of the fluid in the channel portion 50 are available at the downstream end 54 of the channel portion 50.

The transition between the recess fluid inlet portion 48 and the channel portion 50 is continuous which means that no step or edge is on the inner surface 56 of the recess 46 in the transition between the recess fluid inlet portion 48 and the channel portion 50. Consequently, the pressure losses at the upstream end 52 of the channel portion 50 can be small and the fluid flow speed at the downstream end 54 of the channel portion 50 can be large. This means that the tangential speed of the fluid flow when the fluid enters the fluid outlet portion 44 can be large which can result in a large radial component of the fluid flow and the distribution of the fluid in radial direction can be very good. This can result in an increased spray angle of the fluid flow through the injection nozzle 24 and a good distribution of droplets of the spray.

In the embodiment of FIG. 4, the channel portion has a conical shape. Conical shapes are simple to manufacture and a good adjustment of the channel portion 50 to the recess fluid inlet portion 48 is possible. This allows a stepless transition between the channel portion 50 and the recess fluid inlet portion 48. By this, small pressure losses at the upstream end 52 of the channel portion 50 and high fluid flow velocities at the downstream end 54 of the channel portion 50 are possible.

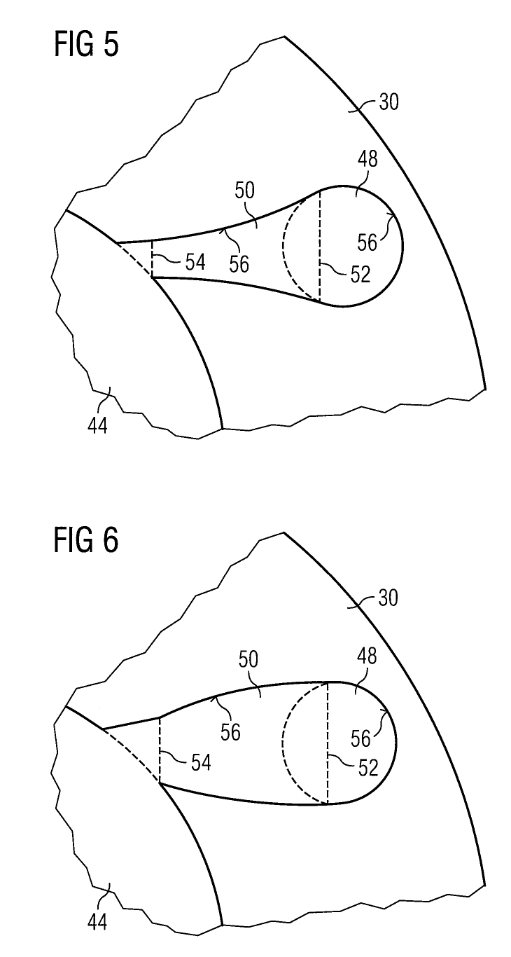

According to a further embodiment, the channel portion 50 has a convex shape (FIG. 5) or a concave shape having the shape of a drop (FIG. 6). These two embodiments allow good adaptation of the channel portion 50 to the recess fluid inlet portion 48 with a stepless transition between the channel portion 50 and the recess fluid inlet portion 48.

In the following, the function of the injection valve 10 being described in detail:

The fluid is led from the fluid inlet portion 42 to the fluid outlet portion 44. The axial position of the valve needle 10, which determines whether the fluid outlet portion 44 is opened or closed for a fluid flow, depends on the force balance between the spring 14 and the forces applied to the valve needle 10 by the actuator unit with the coil 36.

The fluid flow through the fluid outlet portion 44 can be described with a flow path 68 with flow path sections 68a, 68b.

The fluid flow on the flow path 68 is passing the fluid flow directing element 30 thereby being accelerated in the channel portion 50. By this the fluid flow obtains a radial velocity component which results in a distribution of droplets in a spray in the flow path section 68b of the second flow path 68.

The radial component of the fluid flow velocity on the flow path section 68b is high and a good distribution of fluid in radial direction is available. Therefore the fluid flow through the injection nozzle 24 generating a spray can result in a large spray angle and a good distribution of the droplets of the spray.

What is claimed is:

1. A valve assembly for an injection valve, comprising
a valve body including a central longitudinal axis, the valve body comprising a cavity with a fluid inlet portion and a fluid outlet portion,
a valve needle axially movable in the cavity, the valve needle preventing a fluid flow through the fluid outlet portion in a closing position and releasing the fluid flow through the fluid outlet portion in further positions, and
a fluid flow directing element arranged in the cavity and comprising a recess to direct the fluid flow to the fluid outlet portion, the recess having a recess fluid inlet portion and a channel portion arranged between the recess fluid inlet portion and the fluid outlet portion, the channel portion having an upstream end and a downstream end, and a cross section of the downstream end of the channel portion being smaller than a cross section of the upstream end of the channel portion.

2. The valve assembly according to claim 1, wherein the cross section of the channel portion is decreasing continuously from the upstream end of the channel portion to the downstream end of the channel portion.

3. The valve assembly according to claim 1, wherein the recess fluid inlet portion and the channel portion are formed and arranged in a way that the transition between the recess fluid inlet portion and the channel portion is stepless.

4. The valve assembly according to claim 1, wherein the channel portion has a conical shape.

5. The valve assembly according to claim 1, wherein a longitudinal section of the channel portion is of a convex shape.

6. The valve assembly according to claim 1, wherein a longitudinal section of the channel portion is of a concave shape.

7. An injection valve comprising
a valve assembly comprising
a valve body including a central longitudinal axis, the valve body comprising a cavity with a fluid inlet portion and a fluid outlet portion,
a valve needle axially movable in the cavity, the valve needle preventing a fluid flow through the fluid outlet portion in a closing position and releasing the fluid flow through the fluid outlet portion in further positions, and
a fluid flow directing element arranged in the cavity and comprising a recess to direct the fluid flow to the fluid outlet portion, the recess having a recess fluid inlet portion and a channel portion arranged between the recess fluid inlet portion and the fluid outlet portion, the channel portion having an upstream end and a downstream end, and a cross section of the downstream end of the channel portion being smaller than a cross section of the upstream end of the channel portion.

8. The injection valve according to claim 7, wherein the cross section of the channel portion is decreasing continuously from the upstream end of the channel portion to the downstream end of the channel portion.

9. The injection valve according to claim 7, wherein the recess fluid inlet portion and the channel portion are formed and arranged in a way that the transition between the recess fluid inlet portion and the channel portion is stepless.

10. The injection valve according to claim 7, wherein the channel portion has a conical shape.

11. The injection valve according to claim 7, wherein a longitudinal section of the channel portion is of a convex shape.

12. The injection valve according to claim 7, wherein a longitudinal section of the channel portion is of a concave shape.

13. A valve assembly for an injection valve, comprising
a valve body having a central longitudinal axis and comprising a cavity with a fluid inlet portion and a fluid outlet portion,
a valve needle axially movable in the cavity for closing an opening of the valve assembly, and
a fluid flow directing element arranged in the cavity and comprising a recess to direct the fluid flow to the fluid outlet portion, the recess having a recess fluid inlet portion and a channel portion arranged between the recess fluid inlet portion and the fluid outlet portion, and a cross section of the recess fluid inlet portion being greater than a cross section of the channel portion.

14. The valve assembly according to claim 13, wherein the cross section of the channel portion is decreasing continuously from an upstream end of the channel portion to a downstream end of the channel portion.

15. The valve assembly according to claim 13, wherein the recess fluid inlet portion and the channel portion are formed and arranged in a way that the transition between the recess fluid inlet portion and the channel portion is stepless.

16. The valve assembly according to claim 13, wherein the channel portion has a conical shape.

17. The valve assembly according to claim 13, wherein a longitudinal section of the channel portion is of a convex shape.

18. The valve assembly according to claim 13, wherein a longitudinal section of the channel portion is of a concave shape.
